(19) United States
(12) Patent Application Publication
(10) Pub. No.: US 2018/0361254 A1
(43) Pub. Date: Dec. 20, 2018

(54) SYSTEM AND METHOD FOR CONTROLLING PLAYER SUCCESS IN A MULTIPLAYER ONLINE GAME

(71) Applicant: Cognant LLC, Mountain View, CA (US)

(72) Inventor: Ethan Anderson, Mountain View, CA (US)

(21) Appl. No.: 15/991,386

(22) Filed: May 29, 2018

Related U.S. Application Data
(60) Provisional application No. 62/520,223, filed on Jun. 15, 2017.

(51) Int. Cl. A63F 13/798; A63F 13/33; A63F 13/352; A63F 13/45; G06F 8/61

(52) U.S. Cl. CPC A63F 13/798; A63F 13/33; A63F 2300/5546; A63F 13/45; G06F 8/61; A63F 13/352

(57) ABSTRACT

A method, a system, and an article are provided for controlling user success or advancement in an online game or other software application. An example computer-implemented method can include: providing an online game for a plurality of users; assigning the users to a plurality of groups; determining a target success rate in the online game for a first group of users from the plurality of groups; determining an actual success rate in the online game for the first group of users; adjusting a difficulty of the online game to reduce a difference between the actual success rate and the target success rate.

### CROSS-REFERENCE TO RELATED APPLICATIONS

This application claims the benefit of U.S. Provisional Patent Application No. 62/520,223, filed Jun. 15, 2017, the entire contents of which are incorporated by reference herein.

### BACKGROUND

The present disclosure relates generally to computer games and, in some examples, to systems and methods for controlling rates at which users can advance or achieve success in multiplayer online games.

In general, a multiplayer online game can be played by hundreds of thousands or even millions of players who use client devices to interact with a virtual environment for the online game. The players are typically working to accomplish tasks, acquire assets, or achieve a certain score or level in the online game. Some games require or encourage players to form groups or teams that can play against other players or groups of players. As players achieve success in the game, the players can advance to higher, more difficult levels.

### SUMMARY

In general, the subject matter described herein can be used to control a rate at which users (also referred to herein as players) can achieve success in a computer game, such as a multiplayer online game, or other software application. In a typical example, the users of a multiplayer online game can be assigned to one or more user groups, and a desired or target success rate can be assigned to at least one of the groups. An actual success rate for the group can be determined and compared with the target success rate. Based on a difference between the actual success rate and the target success rate, a difficulty of the game can be adjusted for the group to reduce or eliminate the difference, over time. Techniques used to control the user success rate can include, for example, proportional control, integral control, and/or derivative control.

Advantageously, the systems and methods described herein can allow game developers or managers to independently specify and achieve a target success rate for individual users or groups of users in the online game. In various instances, for example, game difficulty can be adjusted for a single user or group of users while maintaining or separately adjusting a game difficulty for another user or group of users. For example, when a group of users is achieving success at a rate that is higher than a desired or target success rate, the game can be made more difficult for that group of users. Likewise, the game can be made less difficult for a group of users that is achieving success at a rate that is lower than the target success rate. In general, the ability to independently control success rates can allow game developers and managers to level the playing field, make the game more competitive, and/or improve overall user interest in the online game.

In one aspect, the subject matter described in this specification relates to a computer-implemented method. The method includes: providing an online game for a plurality of users; assigning the users to a plurality of groups; determining a target success rate in the online game for a first group of users from the plurality of groups; determining an actual success rate in the online game for the first group of users; and adjusting a difficulty of the online game to reduce a difference between the actual success rate and the target success rate.

In certain examples, the users can be assigned to the plurality of groups according to a game installation history for the users. The game installation history can include at least one offer to install and play the online game. In some instances, each user in the first group of users selected the at least one offer. The actual success rate can include a rate of advancement in the online game. The actual success rate can include an average success rate among the users in the first group.

In various implementations, adjusting the difficulty can include adjusting at least one game play parameter according to the difference between the actual success rate and the target success rate. Adjusting the difficulty can include using a proportional control scheme to control the actual success rate. Adjusting the difficulty can further include using at least one of an integral control scheme and a derivative control scheme to control the actual success rate. Adjusting the difficulty can include maintaining the difficulty of the online game at a current level for a second group of users.

In another aspect, the subject matter described in this specification relates to a system. The system includes one or more computer processors programmed to perform operations including: providing an online game for a plurality of users; assigning the users to a plurality of groups; determining a target success rate in the online game for a first group of users from the plurality of groups; determining an actual success rate in the online game for the first group of users; and adjusting a difficulty of the online game to reduce a difference between the actual success rate and the target success rate.

In certain implementations, the users can be assigned to the plurality of groups according to a game installation history for the users. The game installation history can include at least one offer to install and play the online game. In some instances, each user in the first group of users selected the at least one offer. The actual success rate can include a rate of advancement in the online game. The actual success rate can include an average success rate among the users in the first group.

In various examples, adjusting the difficulty can include adjusting at least one game play parameter according to the difference between the actual success rate and the target success rate. Adjusting the difficulty can include using a proportional control scheme to control the actual success rate. Adjusting the difficulty can further include using at least one of an integral control scheme and a derivative control scheme to control the actual success rate. Adjusting the difficulty can include maintaining the difficulty of the online game at a current level for a second group of users.

In another aspect, the subject matter described in this specification relates to an article. The article includes a non-transitory computer-readable medium having instructions stored thereon that, when executed by one or more computer processors, cause the computer processors to perform operations including: providing an online game for a plurality of users; assigning the users to a plurality of groups; determining a target success rate in the online game for a first group of users from the plurality of groups; determining an actual success rate in the online game for the first group of users; and adjusting a difficulty of the online game to reduce a difference between the actual success rate and the target success rate.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for controlling user success in a multiplayer online game.

FIG. 2 is a schematic diagram of an example method of controlling user success in a multiplayer online game.

FIG. 3 is a schematic diagram of an example control system for controlling user success in a multiplayer online game.

FIG. 4 is a flowchart of an example method of controlling user success in a multiplayer online game.

### DETAILED DESCRIPTION

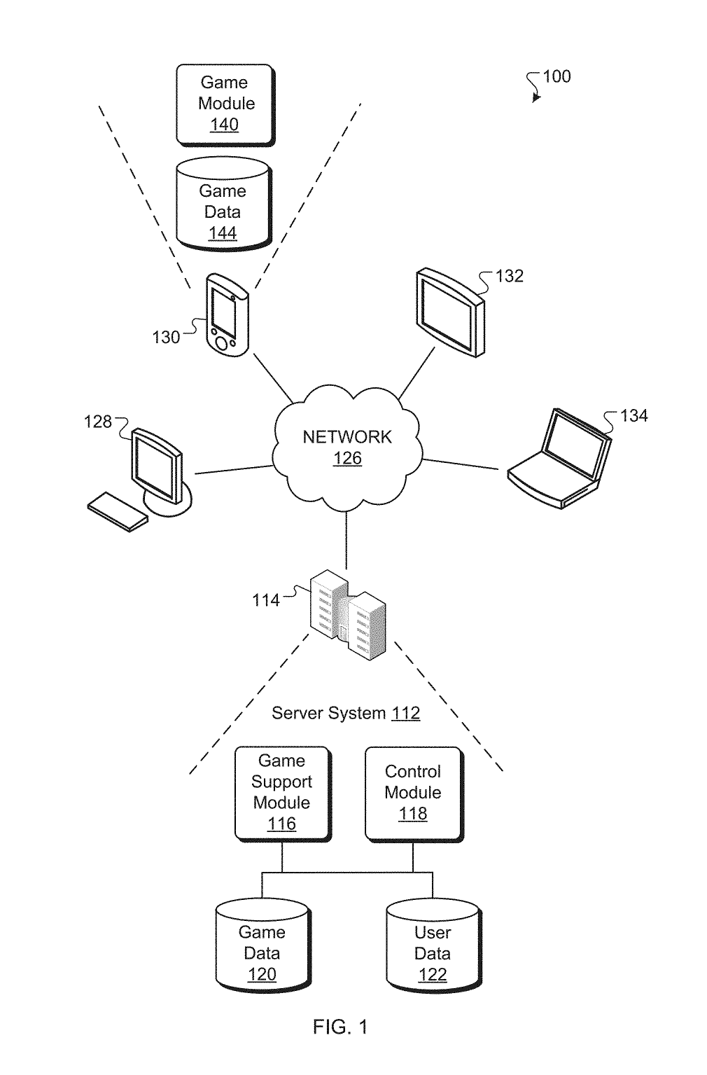

FIG. 1 illustrates an example system 100 for providing an online game, such as a massively multiplayer online game, to a plurality of users (alternatively referred to herein as “players”). A server system 112 provides functionality for controlling a rate of user success or advancement in the online game. The server system 112 includes software components and databases that can be deployed at one or more data centers 114 in one or more geographic locations, for example. The server system 112 software components can include a game support module 116 and a control module 118. The software components can include subcomponents that can execute on the same or on different individual data processing apparatus. The server system 112 databases can include game data 120 and user data 122 databases. The databases can reside in one or more physical storage systems. The software components and data will be further described below.

The online game can be accessed through a network 126 (e.g., the Internet) by users of client devices, such as a personal computer 128, a smart phone 130, a tablet computer 132, and a laptop computer 134. Other client devices are possible. Each client device in the system 100 can utilize or include software components and databases for providing the online game. The software components on the client devices can include a game module 140, which can implement the online game on each client device. The databases on the client devices can include a game data 144 database, which can store data for the online game and exchange data with the game module 140. The data stored on the game data 144 database can include, for example, user data, image data, video data, game rules, data for virtual items or virtual characters, data for a virtual environment, and any other data or content used or generated by the game module 140, the game support module 116, and/or the control module 118. While the game module 140 and the game data 144 database are depicted as being associated with the smart phone 130, it is understood that other client devices (e.g., the personal computer 128, the tablet computer 132, and/or the laptop computer 134) can include the game module 140, the game data 144 database, and any portions thereof.

In some examples, the game support module 116 includes one or more software components that support the software application by, for example, performing calculations, implementing software updates, exchanging information, content, or data with the game module 140, and/or monitoring an overall status of the online game. The game support module 116 can retrieve data from the game data 120 database and/or the user data 122 database.

FIG. 1 depicts the game support module 116 and the control module 118 as being able to communicate with the databases (e.g., the game data 120 and the user data 122 databases). The game data 120 database generally includes data that the game support module 116 uses to provide the online game. Such data can be or include, for example, image data, video data, game rules, data for virtual items or virtual characters, data for a virtual environment, and any other data or content used or generated by the game support module 116 and/or the control module 118. The user data 122 database generally includes information related to user interactions with the client devices 128, 130, 132, and 134 and/or the server system 112. Such information can be or include, for example, a history of user connections to and/or interactions with the online game and/or the system 100, a history of content presented to users, user installations, user purchases, user accomplishments, user tasks, and/or user interactions with other users (e.g., group chats). While FIG. 1 depicts the game support module 116 and the control module 118 as being part of the server system 112, it is understood that the game support module 116, the control module 118, or any portions thereof can reside on or be implemented by the client devices 128, 130, 132, and 134.

In various examples, the users or players can have certain user capabilities in the online game. The user capabilities can be or include, for example, moving an avatar or a virtual item or object to a different geographical location in a virtual environment, interacting with characters or other users, attacking other users, deploying troops, defending against an attack from other users, deploying defenses, building or modifying a virtual item or object (e.g., a virtual building or other structure), developing a new skill, operating a vehicle, acquiring a virtual item (e.g., a weapon), using or interacting with a virtual item (e.g., a playing card or a weapon), and performing supernatural tasks (e.g., casting a spell). Other user capabilities are possible. Additionally or alternatively, the online game can include one or more virtual items for use in the virtual environment. The virtual items can be or include, for example, a virtual vehicle, a virtual weapon, a virtual defense, a virtual building or other structure, a virtual playing card, a virtual currency, and/or any other virtual asset that can be present or used in the virtual environment.

In certain implementations, the success rate for a user or group of users in the online game can be, include, or represent, for example, a rate of advancement (e.g., in levels, points, or assets) over a period of time (e.g., hours or days). For example, the success rate for a user can be a number of levels that the user advanced (or a number of points earned) during the previous day, the previous week, or since the user began playing the online game. Additionally or alternatively, the success rate for a group of users can be, include, or represent, for example, a percentage or fraction of the users in the group who have reached a threshold level of accomplishment in the online game, such as a specified user level, number of points, value of assets, or the like. For example, if 3 out of 10 users in a group have reached level 10, the success rate for reaching level 10 for the group can be 30% or 0.3.

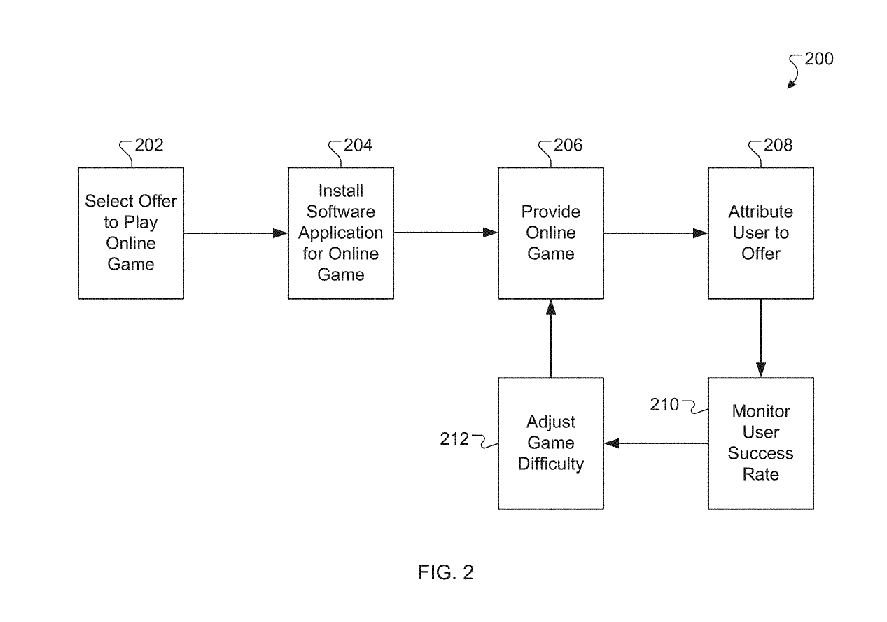

Referring to FIG. 2, in certain examples, a method 200 of controlling user success in the online game can involve monitoring a success rate for a user or group of users and, based thereon, adjusting a difficulty of the game to achieve a desired or target success rate for the user or group of users. As depicted, the method 200 can begin when a user of a client device (e.g., the client device 130) selects (step 202) an offer to play the online game. The selected offer can direct the client device to an online store or other website where the user can download and install (step 204) a software application (e.g., the game module 140) for the online game. This history of the user installing the game after selecting the offer can be stored as an installation history, for example, in the user data 122 database. In general, the installation history can include information related to how and/or when a user or group or users first installed and began using the online game (e.g., by selecting the offer).

Once the game is installed and launched, the online game can be provided (step 206) on the client device. In the depicted example, the online game can attribute (step 208) the user to the offer. This can involve, for example, retrieving the installation history to determine that the user installed, began playing, or otherwise arrived at the online game after selecting the offer. Next, the success rate for the user in the online game can be monitored (step 210) over time, for example, based on a rate (e.g., in time) of advancement or achievement in the online game. Such advancement or achievement can include, for example, advancing to a certain game level (e.g., level 5 or level 10), achieving a certain score, defeating one or more competitors, and/or acquiring one or more virtual items or objects. Alternatively or additionally, the user can be assigned to a group of users who selected the offer and/or have an identical or similar installation history. In that case, the success rate for the user and other users in the group can be, for example, an average, a median, a minimum, or a maximum success rate for the users. In some instances, the success rate can be a fraction or percentage of the users in the group who have achieved a specified level of advancement (e.g., a threshold score or game level) in the game.

Next, the difficulty of the online game can be adjusted (step 212) for the user (or the group of users) according to the monitored, actual success rate and the target success rate. For example, when the user's actual success rate exceeds the target success rate, the game can be made more difficult for the user, to decrease the actual success rate closer to the target success rate. Likewise, when the user's actual success rate is less than the target success rate, the game can be made less difficult for the user, to increase the actual success rate closer to the target success rate. Any combination of steps 206, 208, 210, and 212 can be repeated as the user continues to play the online game.

In some instances, the target success rate can be defined or determined (e.g., by a developer or manager of the online game) in an effort to optimize game enjoyment, improve competitiveness, and/or manage expenses. The target success rate can, in certain examples, be associated with the user and any similar users who arrived at the online game by selecting the offer. Other users, who arrived at the online game through a different route (e.g., a different offer), can have a different target success rate and/or can be monitored separately.

In some examples, the difficulty of the online game can be adjusted by changing one or more game play parameters. The game play parameters can include or define, for example, a threshold score required to advance to a next game level, an availability of rewards or virtual currency, an availability of virtual assets, a capability of a virtual object or other asset, a capability of a user or the user's avatar in a virtual environment, and/or a frequency and/or intensity of obstacles or challenges (e.g., encounters with other competitors). For example, the difficulty of the online game can be adjusted by changing requirements associated with advancing to a higher level. Additionally or alternatively, the difficulty can be adjusted by changing a value, a strength, a power, and/or an effectiveness of virtual characters or virtual items. For example, the difficulty can be increased by making a user's avatar slower or weaker and/or by making a user's virtual weapon (e.g., a virtual gun) or defenses (e.g., a virtual wall) less effective. Other methods of adjusting game difficulty are possible. For example, in some instances, the difficulty can be adjusted by selecting a difficulty setting from a number (e.g., 5 or 10) of available difficulty settings for the online game. Each difficulty setting can utilize or include a unique combination of game play parameters.

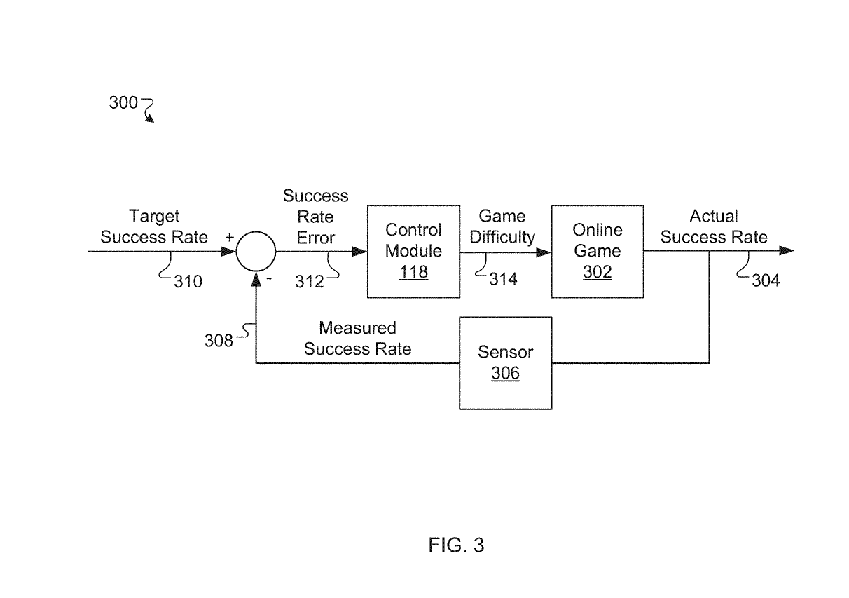

Referring to FIG. 3, in certain examples, a process control scheme 300 can be used to control a success rate for a user or a group of users of an online game 302. As the online game 302 is played, the user or the group of users can achieve a certain actual success rate 304. A sensor 306 can be used to monitor the actual success rate 304 and provide a measured success rate 308. The sensor 306 can be or include, for example, a software component incorporated into the control module 118, the game module 140, and/or the game support module 116. The sensor 306 can track user progress and activity in the online game, for example, by acquiring or receiving periodic status updates for users. The measured success rate 306 can be compared with a target success rate 310 to determine a success rate error 312. The success rate error 312 can be, for example, a difference between the measured success rate 308 and the target success rate 310. The control module 118 can then use the success rate error 312 to determine a game difficulty 314 for the online game 302. As described herein, the control module 118 can make the game more or less difficult in an effort to reduce or eliminate the success rate error 312.

In various examples, the control module 118 can use a proportional control technique to determine the game difficulty 314 according to:

Dₒᵤₜ=Kₚe+D_{zero} (1)

where Dₒᵤₜ is the game difficulty 314, Kₚ is a proportional gain, e is the success rate error 312, and D_{zero} is the game difficulty 314 when the success rate error 312 is zero. A suitable value for the proportional gain Kₚ is generally game dependent and can be determined through experimentation. Additionally or alternatively, integral and/or derivative control techniques (e.g., PI, PD, or PID control) can be used to control the success rate. With integral control, for example, the control module 118 can determine the game difficulty 314 based on an integral of the success rate error 312 over time. This can help push the success rate error 312 to zero as time progresses. With derivative control, the control module 118 can determine the game difficulty 314 based on a current rate of change of the success rate error 312. PID control can be expressed mathematically as:

$${D}_{out} = {K}_{p} e ( t ) + {K}_{i} {\int }_{0}^{t} e ( t ) dt + {K}_{d} \frac{de ( t )}{dt} + {D}_{zero} , \qquad ( 2 )$$

where t is time and Kᵢ and K_{d} are coefficients or gains for the integral and derivate control terms, respectively.

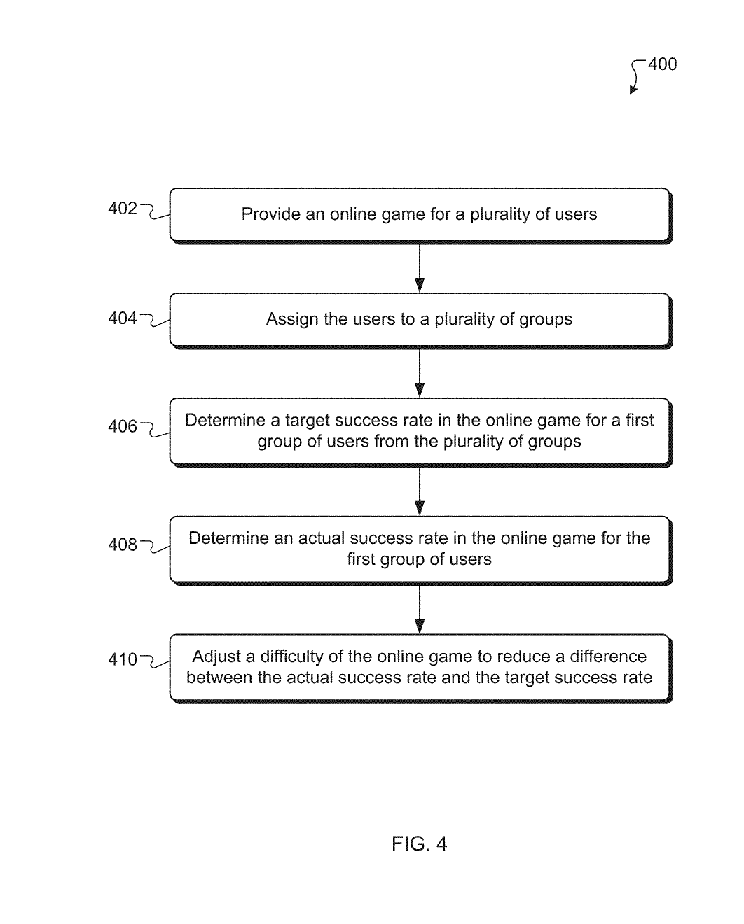

FIG. 4 illustrates an example computer-implemented method 400 of controlling player success in a multiplayer online game. An online game is provided (step 402) for a plurality of users. The users are assigned (step 404) to a plurality of groups, for example, according to an installation history for the plurality of users. A target success rate in the online game is determined (step 406) for a first group of users from the plurality of groups. An actual success rate is determined (step 408) in the online game for the first group of users. A difficulty of the online game is adjusted (step 410) to reduce a difference between the actual success rate and the target success rate.

In various instances, a user can download and begin playing the online game after selecting an offer to play the online game. For example, digital advertisers can pay intermediaries, such as an advertiser network (“ad network”), based on a conversion event that goes beyond merely visiting a page or installing a software application. For instance, a developer of a mobile application (e.g., for an online game) can pay an ad network for each user that not only installs the application, but subsequently reaches a certain score or level (e.g., level 10) in the application. Under such a model, referred to herein as “CPE” or “cost-per-engagement,” the number of users who reach the conversion event relative to the number of users who view, click, or install the application (referred to herein as the “conversion percentage”) can directly influence an expense to the advertiser, as well as an advertising revenue earned by the ad network. If a particular marketing campaign has a higher conversion percentage than expected or desired, the advertiser can end up spending more than expected or desired on that traffic source. Similarly, if a marketing campaign has a lower than expected or desired conversion percentage, the advertiser's campaign can be less competitive, relative to campaigns from other demand sources, than the advertiser expected or desired. In some cases, the ad network can automatically pause any advertiser's campaign that fails to meet a minimum conversion percentage threshold.

With the systems and methods described herein, however, advertisers or application managers can dynamically change one or more aspects, features, or functionalities of a website, application, or game to adjust a likelihood that a user or group of users reaches a conversion event, thereby increasing or decreasing the conversion percentage of a given digital marketing campaign. For example, a mobile application game developer or manager can pay an ad network for every new user attributed to that ad network who both (i) installs the mobile game and (ii) reaches level 10. The mobile application game developer can also have a target conversion percentage or success rate of, for example, 25% for each marketing campaign associated with the developer's game. As actual user data becomes available (e.g., as the game is installed and played) at the campaign level, the actual conversion percentage or success rate for a particular campaign may be observed at 15%. In response to this observation, the systems and methods described herein can dynamically decrease the game difficulty or other elements of the game experience for users associated with the campaign (e.g., users who installed and began playing the game after selecting an advertisement or offer for the campaign). For example, game difficulty can be adjusted for existing users who have already begun playing the game. Such adjustments can be made based on a comparison between the target success rate and the actual success rate, as described herein. Additionally or alternatively, game difficulty can be adjusted for new users who recently installed the game but have not yet begun playing the game. In that case, such adjustments can be made at the beginning of the game and further adjustments can be made going forward, if desired, based on future comparisons between the target success rate and the actual success rate. By decreasing the game difficulty in this example, the systems and methods can increase a likelihood of the users reaching the conversion event.

For example, referring again to FIG. 2, when the online game is first provided to a user at step 206 of the method 200, the online game can come with, for example, N different difficulty levels, with 1 being the easiest and N being the hardest, and where N can be any suitable number. At step 208, the user can be associated with a specific offer (e.g., an advertising campaign). Attribution logic for making this association can be handled by, for example, an appropriate third party attribution service provider or the like, which can inform the online game about the specific advertising campaign to which the user is attributed. At step 210, the user success rate can be monitored or determined, for example, to determine how many users associated with the offer have reached a conversion event (e.g., a target level or score) associated with the offer. For example, the control module 118 can calculate the actual CPE percentage relative to the target CPE percentage for the specific offer. At step 212, the control module 118 can adjust the difficulty level for the online game, as described herein, to drive the actual CPE percentage to the target CPE percentage.

In various examples, the dynamic adjustments (e.g., to game difficulty) for the online game can be performed either before or at launch of the game, or at any suitable time while the user is playing the game. The online game can have a default difficulty setting that can be dynamically changed at any time, as described herein. Alternatively, the online game can have no default difficulty setting, such that the difficulty setting can be determined and established at launch of the online game or application and modified at any later time, as desired.

In some instances, the game difficulty settings can be determined or adjusted for each user upon download, installation, and/or launch of the online game or software application, or for any subset of such users. For example, the comparison of the actual CPE percentage versus the target CPE percentage can be calculated for every new Mth user of the online game, where M can be any suitable integer greater than zero. This approach can be used to determine an appropriate difficulty setting, which can be used for additional new users until the calculation is performed again for the next Mth user. For example, the difficulty setting can be updated at user M and used until a new difficulty setting is determined at user 2M.

For purposes of illustration, in one example, a mobile application game developer can run a mobile user acquisition campaign with an ad network in which the developer pays $1.00 to the ad network for every new user attributed to that ad network that both (i) installs the mobile game and (ii) reaches level 5. The ad network can run the campaign on 3 different publishers, Publisher A, Publisher B, and Publisher C, with CPE percentages of 80%, 40%, and 30%, respectively. Without using the systems and methods described herein, the advertiser can end up paying effective costs per install of $0.80, $0.40, and $0.30, respectively, for these publishers. If the advertiser has budgeted an effective $0.30 per install, the advertiser can end up paying more than expected for traffic from Publisher A and Publisher B, but the expected amount for traffic from Publisher C.

With the systems and methods described herein, however, the advertiser can specify a target 30% CPE percentage either at the ad network level, at the individual publisher level, or at an even more granular level (e.g. carrier, OS version, day of the week, etc.). If set at the ad network level, once the actual CPE percentage from the ad network is observed to be over 30%, the control module 118 can increase game difficulty so that new users attributed to Publisher A, Publisher B, and Publisher C can experience a more difficult game experience, thereby reducing the likelihood of the users reaching level 5. The game difficulty can be further adjusted, as needed, to drive the observed CPE percentage to the target 30%, as described herein.

Additionally or alternatively, if the 30% target is set at the publisher level, the control module 118 can adjust game difficulty according to publisher. In this case, users acquired from Publisher A can receive a much more difficult experience (to drop the CPE percentage from 80% to 30%), users acquired from Publisher B can receive a marginally more difficult game experience (to drop the CPE percentage from 40% to 30%), and users driven from Publisher C may need no difficulty adjustment at all, given that the CPE percentage for Publisher C is already at the target level.

In another example, the control module 118 can adjust game difficulty based on a completion rate of an earlier event, even though the CPE may be based on completion of a later event. For example, as with the previous example, an advertiser can pay $1.00 to the ad network for every new user that installs the mobile game and reaches level 5. Further, the advertiser can budget $0.30 effective cost per install, and, thus, can have a target level 5 completion rate of 30%. The control module 118 can determine (e.g., based on historical data in the game data 120 database or user data 122 database) that 50% of the users who reach level 3 typically progress to level 5. Given this determination, the control module 118 can adjust difficulty based on the observed level 3 completion rate at the ad network level, publisher level, or even more granular level. For instance, if the control module 118 observes that 90% of the users from Publisher D reach level 3, the control module 118 can conclude that, absent any difficulty adjustment, 45% of those users will ultimately reach level 5. In response, the control module can dynamically adjust the difficulty level for those users who have not yet reached level 5, in an attempt to drive the actual level 5 completion to the desired 30%, rather than the projected 45%.

In another example, an advertiser paying on a CPE, such as $1.00 per level 5 completion, may observe that when level 5 completion rates are 30% or higher on a particular ad network the advertiser can hit a daily spend and/or install goals for that ad network. However, when the advertiser's CPE percentage falls below 30%, the advertiser's daily delivery suffers or their campaigns are paused completely. Therefore, the advertiser might surmise that at completion rates below 30%, their campaigns are not attractive enough, relative to other campaigns the ad network could run, to achieve the volume and spend goals the advertiser has set. Advantageously, with the systems and methods described herein, if the control module 118 observes that 20% of installs driven from the ad network typically reach level 5, the control module 118 can make the game experience easier for new users driven by the ad network, until the CPE percentage hits the target 30%. With this approach, users can still be required to progress from level 1 to level 5, but should find that journey less challenging. Alternatively or additionally, the control module 118 can change the game experience completely, for instance by having a subset of new users driven from the ad network jump immediately from level 1 to level 5, without having to first progress through Levels 2-4. By adjusting the percentage of new users from the ad network that immediately progress from level 1 to level 5, the control module 118 can increase or decrease the CPE percentage observed for the ad network, thereby increasing the likelihood of hitting the target value.

While much of the discussion above relates to computer games, the systems and methods described herein have applications in other contexts. For example, in the context of a software application for ride sharing, a ride share company can offer bonuses to drivers who give a certain number of rides (e.g., 10 or 20) per week, and the company can have a target of paying out a total value (e.g., $1,000 or $10,000) of aggregate bonuses per week. When the company is projected to be below the payout target for a given week, the systems and methods can be used to make it easier for drivers to become bonus-eligible. For example, the software application can be adjusted to provide underperforming drivers with short or easy rides, so that more drivers can hit the bonus eligibility threshold. Additionally or alternatively, in the context of ecommerce, a certain number of users can visit a company's webpage for a particular product. The company may set a goal of having a certain percentage (e.g., 10% or 20%) of these users place an order for the product. When the rate at which users are placing orders deviates from the goal, the systems and methods can adjust the webpage or a software application for the webpage to change user behavior. For example, the systems and methods can automatically lower the price when order activity is below the goal.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., offer hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method, comprising:
providing an online game for a plurality of users;
assigning the users to a plurality of groups;
determining a target success rate in the online game for a first group of users from the plurality of groups;
determining an actual success rate in the online game for the first group of users; and
adjusting a difficulty of the online game to reduce a difference between the actual success rate and the target success rate.

2. The method of claim 1, wherein the users are assigned to the plurality of groups according to a game installation history for the users.

3. The method of claim 2, wherein the game installation history comprises at least one offer to install and play the online game.

4. The method of claim 3, wherein each user in the first group of users selected the at least one offer.

5. The method of claim 1, wherein the actual success rate comprises a rate of advancement in the online game.

6. The method of claim 1, wherein the actual success rate comprises an average success rate among the users in the first group.

7. The method of claim 1, wherein adjusting the difficulty comprises adjusting at least one game play parameter according to the difference between the actual success rate and the target success rate.

8. The method of claim 1, wherein adjusting the difficulty comprises:
using a proportional control scheme to control the actual success rate.

9. The method of claim 8, wherein adjusting the difficulty further comprises:
using at least one of an integral control scheme and a derivative control scheme to control the actual success rate.

10. The method of claim 1, wherein adjusting the difficulty comprises:
maintaining the difficulty of the online game at a current level for a second group of users.

11. A system, comprising:
one or more computer processors programmed to perform operations comprising:
providing an online game for a plurality of users;
assigning the users to a plurality of groups;
determining a target success rate in the online game for a first group of users from the plurality of groups;
determining an actual success rate in the online game for the first group of users; and
adjusting a difficulty of the online game to reduce a difference between the actual success rate and the target success rate.

12. The system of claim 11, wherein the users are assigned to the plurality of groups according to a game installation history for the users.

13. The system of claim 12, wherein the game installation history comprises at least one offer to install and play the online game.

14. The system of claim 11, wherein the actual success rate comprises a rate of advancement in the online game.

15. The system of claim 11, wherein the actual success rate comprises an average success rate among the users in the first group.

16. The system of claim 11, wherein adjusting the difficulty comprises adjusting at least one game play parameter according to the difference between the actual success rate and the target success rate.

17. The system of claim 11, wherein adjusting the difficulty comprises:
using a proportional control scheme to control the actual success rate.

18. The system of claim 17, wherein adjusting the difficulty further comprises:
using at least one of an integral control scheme and a derivative control scheme to control the actual success rate.

19. The system of claim 11, wherein adjusting the difficulty comprises:
maintaining the difficulty of the online game at a current level for a second group of users.

20. An article, comprising:
a non-transitory computer-readable medium having instructions stored thereon that, when executed by one or more computer processors, cause the computer processors to perform operations comprising:
providing an online game for a plurality of users;
assigning the users to a plurality of groups;
determining a target success rate in the online game for a first group of users from the plurality of groups;
determining an actual success rate in the online game for the first group of users; and
adjusting a difficulty of the online game to reduce a difference between the actual success rate and the target success rate.
